(19) United States
(12) Patent Application Publication
(10) Pub. No.: US 2018/0081850 A1
(43) Pub. Date: Mar. 22, 2018

(54) TRANSMISSION DEVICE HAVING DATA STORAGE FUNCTION AND CAPABLE OF BEING IN A FOLDED STATE BY MAGNETIC FORCE

(71) Applicant: Shao-Chin TSENG, New Taipei City (TW)

(72) Inventor: Shao-Chin TSENG, New Taipei City (TW)

(21) Appl. No.: 15/358,177

(22) Filed: Nov. 22, 2016

(30) Foreign Application Priority Data
Sep. 22, 2016 (CN) 201621071194.5
Sep. 30, 2016 (CN) 201621095597.3

(51) Int. Cl. G06F 13/42; G06F 13/40; G06F 13/38

(52) U.S. Cl. CPC G06F 13/4282; G06F 13/385; G06F 13/4068

(57) ABSTRACT

A transmission device having a data storage function and capable of being in a folded state by a magnetic force includes a first transmission port (e.g., a Lightning plug) at one end, a second transmission port (e.g., a USB plug) at the other end, a flexible bending portion in the middle section, two magnetically attractive portions respectively adjacent to two opposite ends of the bending portion, and a card reader or data storage unit. Once the first transmission port is connected to a portable device (e.g., a smartphone) to allow the portable device to read data from the transmission device, the bending portion can be bent so that, by the magnetic force of the magnetically attractive portions, the transmission device is rendered into a folded state and is partially hidden behind the portable device to facilitate holding and avoid getting loose and falling off.

### FIELD OF THE INVENTION

The present invention relates to a transmission device, more particularly to a transmission device having a data storage function and capable of being in a folded state by a magnetic force and including a flexible bending portion in its middle section and two magnetically attractive portions respectively adjacent to two opposite ends of the bending portion so that, when only one of the transmission ports of the transmission device is connected to a portable device in order for the portable device to read the data stored in the transmission device, the bending portion can be bent to make the magnetically attractive portions attach to each other, thereby turning the transmission device into a folded state and hiding a portion of the transmission device behind the portable device

### BACKGROUND OF THE INVENTION

With the rapid development of microelectronics, portable devices (e.g., smartphones and tablet computers) have come into extensive use very quickly, giving rise to significant changes in people's habits of life. These portable devices allow their users to search for information, communicate with friends, and/or transfer files anywhere anytime. They may also connect remotely to a webcam in a user's home in order for the user to monitor the indoor environment or the condition of a pet. As such portable devices are typically compact in size, having only a limited data storage space and battery capacity, the need for “recharging” or “data transfer” arises frequently, if not on a regular basis.

A portable device requires a “transmission cable” for charging and file transfer. A transmission cable is a cable with different transmission ports at its two ends. The transmission interfaces of the transmission ports may vary from one brand to another. Take iPhones of Apple Inc. for example. A basic transmission cable for iPhones has a Lightning plug at one end and a USB plug at the other end, wherein the USB plug can be connected to a charger or computer to enable power or data transmission. An alternative transmission cable for iPhones has a Lightning plug at one end and a USB socket at the other end, wherein the USB socket allows an iPhone to connect with and read files from a USB flash drive having the so-called “On the Go” function.

While transmission cables have become indispensable accessories to portable devices and are often carried around by portable device users, they tend to compromise the mobility of the portable devices to which they are connected. More specifically, once a portable device is connected to a USB flash drive through a transmission cable configured for such connection, the user cannot hold the connected assembly freely while walking, for the transmission cable may easily catch on an external object or even fall off the portable device if shaken inadvertently. Furthermore, as mentioned above, a transmission cable configured for connecting with USB flash drives is structurally different from one configured for connecting with chargers, so a single transmission cable cannot satisfy all user needs. In a nutshell, the two major drawbacks of the existing transmission cables are “hindrance to mobility” and “limited functionality”. The issue to be addressed by the present invention, therefore, is to design a novel product structure that can effectively solve the problems of transmission cables in terms of use.

### BRIEF SUMMARY OF THE INVENTION

In view of the fact that a conventional transmission cable tends to hinder the mobility of a portable device user and that transmission cables of different functions must have different structures, the inventor of the present invention incorporated years of practical experience into extensive research, repeated tests, and continued improvement and finally succeeded in developing a transmission device that has a data storage function, can be rendered into a folded state by a magnetic force, and thereby overcomes the aforementioned drawbacks of the conventional transmission cables effectively.

The present invention provides a transmission device having a data storage function and capable of being in a folded state by a magnetic force. The transmission device includes a housing, a first transmission port, a second transmission port, a transmission cable, a card reader (or data storage unit), and two magnetically attractive portions. The middle section of the housing is provided with a bending portion, which is flexible. The transmission ports are provided at two opposite ends of the housing respectively, have different transmission interfaces, and are electrically connected to each other via the transmission cable. The card reader (or data storage unit) is electrically connected to at least one of the transmission ports. The magnetically attractive portions are protrudingly provided on one side of the housing, are respectively adjacent to two opposite ends of the bending portion, and include a magnet and a magnetic element. When the bending portion is bent, the magnetically attractive portions are magnetically attached to each other and thus render the transmission device into a folded state. Once the transmission device is in the folded state and the first transmission port (e.g., a Lightning plug) is connected to a portable device (e.g., an iPhone), the portion of the transmission device that is adjacent to the second transmission port is hidden behind the portable device to reduce not only the size of the connected assembly, but also the possibility of the transmission device getting loose. Moreover, while the connected assembly is held in the user's hand, the folded transmission device is pressed against the user's palm and provides the assembly with a secure feel in the hand.

### BRIEF DESCRIPTION OF THE SEVERAL VIEWS OF THE DRAWINGS

The technical features, method of use, and objectives of the present invention will be better understood by referring to the following detailed description in conjunction with the accompanying drawings, in which:

FIG. 1 is a perspective view showing the transmission device of the present invention in an unfolded state;

FIG. 2 is a perspective view showing the internal structure of the transmission device of the present invention;

FIG. 3 is a side view showing the transmission device of the present invention in a folded state;

FIG. 4 is a perspective view of a protective cover for the transmission device of the present invention;

FIG. 5 is a side view showing how the transmission device of the present invention is connected with the protective cover;

FIG. 6 is a perspective view showing how the transmission device of the present invention and the protective cover jointly form a support; and

FIG. 7 is an exploded perspective view of the second transmission port and the card reader of the transmission device of the present invention.

### DETAILED DESCRIPTION OF THE INVENTION

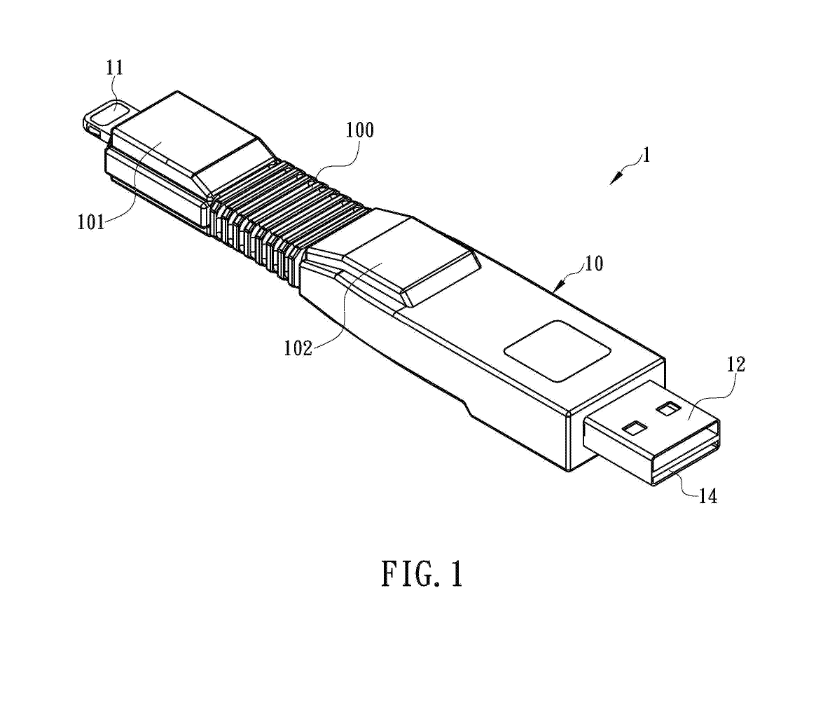

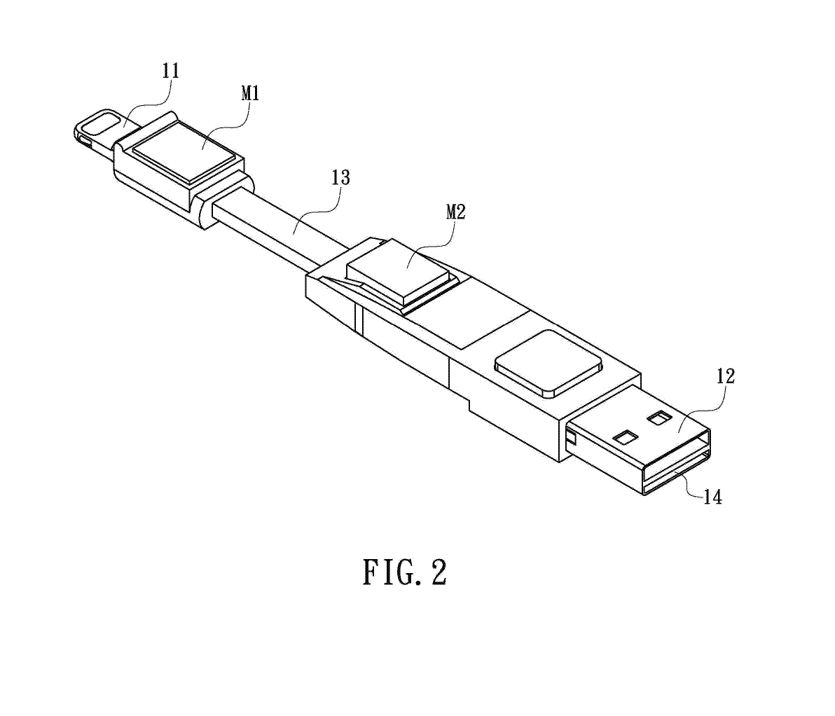

The present invention provides a transmission device that has a data storage function and can be rendered into a folded state by a magnetic force. Referring to FIG. 1 and FIG. 2 for a preferred embodiment of the invention, the transmission device 1 includes a housing 10, a first transmission port 11, a second transmission port 12, a transmission cable 13, a card reader 14 or data storage unit, and two magnetically attractive portions 101 and 102.

The housing 10 is a plastic cladding of the transmission device 1 and in this embodiment is made of a thermoplastic elastomer (TPE) in order for the middle section of the housing 10 to form a flexible bending portion 100. Thermoplastic elastomers are available in a great variety, including thermoplastic polyurethane, polyolefin-based elastomers, polystyrene-based elastomers, and so on; the present invention imposes no limitation in this regard. In fact, the housing 10 or the bending portion 100 can be made of any flexible material or structure (e.g., an elastic tube, pliable plastic, pliable rubber, etc.). It is also feasible to form the two opposite ends of the housing 10 out of a rigid material (e.g., metal) and then mount a separate flexible bending portion between the rigid ends as the middle section of the housing 10. In other words, it is not required that the housing 10 is integrally formed as shown in FIG. 1.

In this embodiment, the bending portion 100 is configured as an integrally formed structure with ridges and valleys alternately arranged in the longitudinal direction. This ridge-and-valley structure is designed as a strain-relief (SR) structure, which is a cable-protecting structure with high structural strength to prevent a cable from being overly bent. The present invention applies the structural properties of an SR structure to the bending portion 100 of the transmission device 1 so that the bending portion 100 can be bent and folded at a fixed angle without causing the thermoplastic elastomer to expand in thickness or deform toward either end.

The first transmission port 11 and the second transmission port 12 are provided at a first end and an opposite second end of the housing 10 respectively. In the embodiment shown in FIG. 1 and FIG. 2, the first transmission port 11 uses the Lightning transmission interface while the second transmission port 12 uses the USB transmission interface (which is different from the transmission interface of the first transmission port 11). As transmission interfaces do not constitute limitations on the present invention, the transmission interface of the first transmission port 11 may alternatively be a mini-USB, micro-USB, or USB Type-C interface.

The transmission cable 13 is provided in the housing 10 and has two ends respectively and electrically connected to the first transmission port 11 and the second transmission port 12. Also, the transmission cable 13 corresponds to the bending portion 100 in order for the bending portion 100 to reduce the stress of the transmission cable 13 when the bending portion 100, and hence the transmission cable 13, are bent.

The transmission device 1 is configured to store data into a memory card connected to the card reader 14 (or into a data storage unit in the transmission device 1). The card reader 14 or data storage unit is electrically connected to at least one of the first transmission port 11 and the second transmission port 12 in order to serve as a USB flash drive. In this embodiment, the card reader 14 (whose structure will be detailed further below) is provided at the end of the transmission device 1 that is adjacent to the second end of the housing 10, and the card reader 14 is separately and electrically connected to the first transmission port 11 and the second transmission port 12.

The magnetically attractive portions 101 and 102 are provided on the same side of the housing 10 and are adjacent to two opposite ends of the bending portion 100 respectively. The magnetically attractive portions 101 and 102 include a magnet and a magnetic element, wherein the magnetic element may be a pliable magnetic material (e.g., a magnetic metal) or a rigid magnetic material (i.e., a magnet). In this embodiment, the magnetically attractive portions 101 and 102 include a first magnet M1 and a second magnet M2. The magnets M1 and M2 are buried in the housing 10 (e.g., by injection molding) to form the first magnetically attractive portion 101 and the second magnetically attractive portion 102 respectively. The magnetically attractive portions 101 and 102 protrude to the same height, and the distance between the first magnet M1 and the bending portion 100 is equal to the distance between the second magnet M2 and the bending portion 100 so that, when the bending portion 100 is bent, the first magnet M1 and the second magnet M2 can be magnetically attached to each other to render the transmission device 1 into a folded state.

Referring to FIG. 1 to FIG. 3, the transmission device 1 can function as a “data storage device” (i.e., a USB flash drive or card reader) as well as a conventional “transmission cable”. The method of use of the transmission device 1 is as follows:

(1) The unfolded state: The transmission device 1 is in an “unfolded state”, e.g., the state shown in FIG. 1, when the bending portion 100 is straight. The transmission device 1 in this state can be used as a conventional transmission cable; that is to say, the first transmission port 11 can be connected to a socket of a portable device 3, and the second transmission port 12, to a charger or computer to carry out power or data transmission.

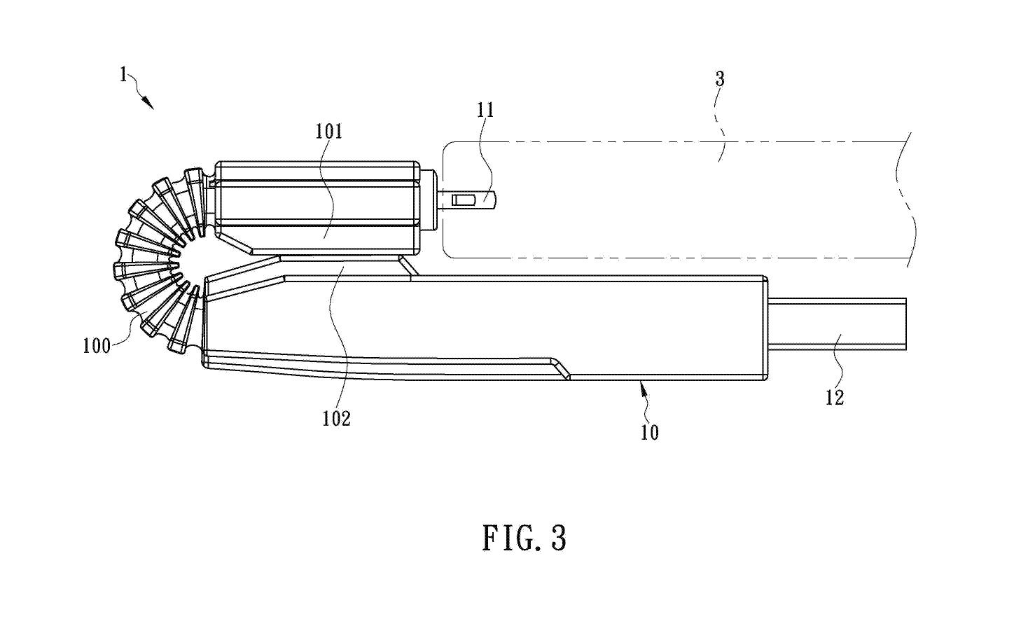

(2) The folded state: The transmission device 1 is equipped with a data storage unit or card reader and is therefore capable of data storage by itself. A user may bend the bending portion 100 and have the first magnet M1 and the second magnet M2 attach to each other, thereby turning the transmission device 1 into the folded state, as shown in FIG. 3. The user may then connect the first transmission port 11 to the portable device 3, leaving the portion of the transmission device 1 that is adjacent to the second transmission port 12 hidden behind the portable device 3. This arrangement keeps the otherwise dangling portion of the transmission device 1 from catching on an external object, which if occurring may pull the transmission device 1 off the portable device 3. In addition, while the user is holding the connected assembly of the portable device 3 and the transmission device 1 singlehandedly, the portion of the transmission device 1 that is adjacent to the second transmission port 12 happens to lie between the user's palm and the back of the portable device 3, giving the connected assembly a secure feel in the hand.

According to the above, the combination of the bending portion 100 and the magnets M1 and M2 allows the transmission device 1 to transform from the original strip-like configuration to a more compact folded configuration when used as a data storage device. The folded configuration not only facilitates holding but also contributes to transmission stability by keeping the transmission device 1 from wobbling.

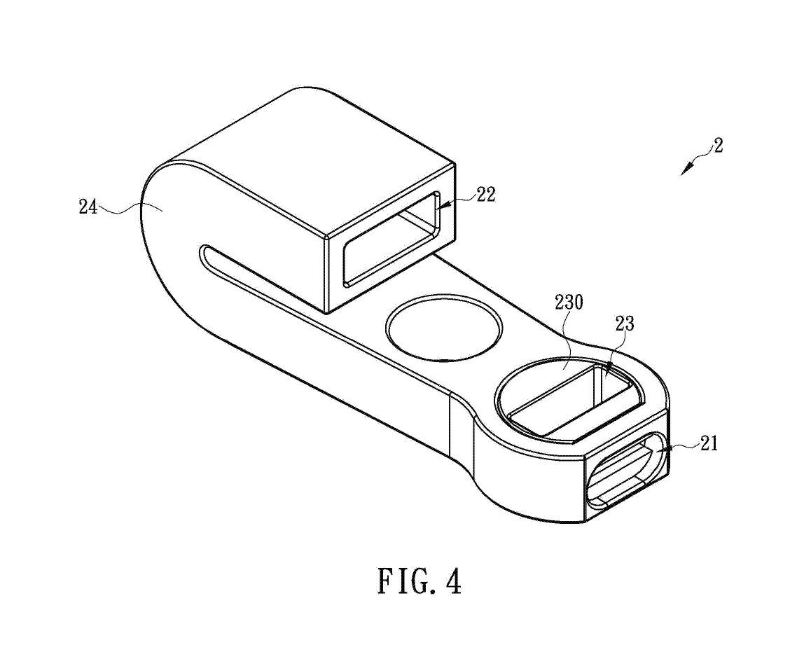

Referring to FIG. 4 in conjunction with FIG. 1 to FIG. 3, the transmission device 1 may be further provided with a protective cover 2. The protective cover 2 includes a first insertion opening 21, a second insertion opening 22, a third insertion opening 23, and a curved portion 24. The first insertion opening 21 is provided at a first end of the protective cover 2 and matches the first transmission port 11 in size and configuration. The second insertion opening 22 is provided at an opposite second end of the protective cover 2 and matches the second transmission port 12 in size and configuration. The third insertion opening 23 is provided in one side of the protective cover 2, lies adjacent to the first end of the protective cover 2, and matches the second transmission port 12 in size and configuration. (In this embodiment, the third insertion opening 23 is in communication with the first insertion opening 21 but is not necessarily so.)

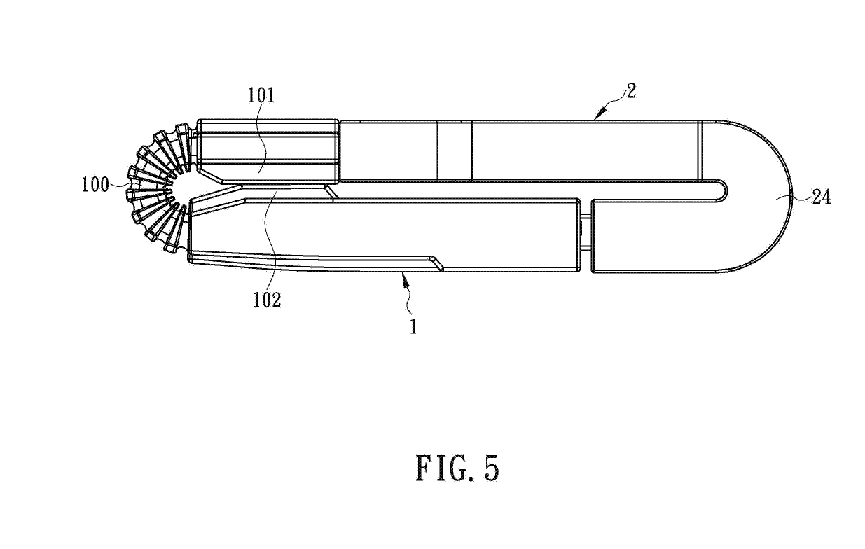

The curved portion 24 is provided in the middle section of the protective cover 2 such that the first insertion opening 21 and the second insertion opening 22 open in the same direction. In this embodiment, the curved portion 24 is made of a rigid material and is inflexible. As shown in FIG. 4 and FIG. 5, the distance between the first insertion opening 21 and the curved portion 24 corresponds to the distance between the second transmission port 12 and the bending portion 100, and the distance between the second insertion opening 22 and the curved portion 24 corresponds to the distance between the first transmission port 11 and the bending portion 100. This technical feature allows the second transmission port 12 to be inserted into the second insertion opening 22 while the first transmission port 11 is inserted in the first insertion opening 21. As shown in FIG. 5, the protective cover 2 can cover the transmission ports 11 and 12 and form a generally O-shape with the transmission device 1 to facilitate carrying.

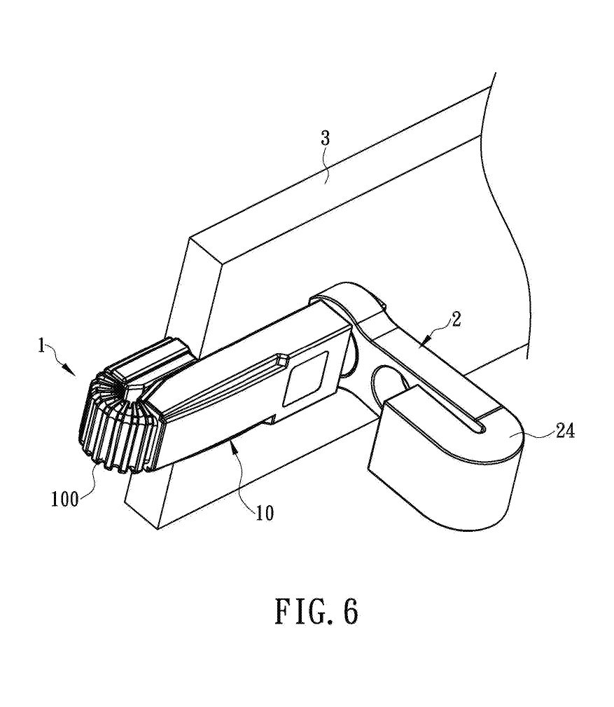

Apart from providing protection, the protective cover 2 can work with the transmission device 1 to serve as a support. Referring to FIG. 6 in conjunction with FIG. 1, FIG. 2 and FIG. 4, the third insertion opening 23 is provided therein with an elastic ring 230 made of an elastic material (e.g., silicone or rubber), and once the second transmission port 12 of the transmission device 1 is inserted in the third insertion opening 23, the elastic ring 230 undergoes elastic deformation and becomes tightly engaged with the second transmission port 12. The curved portion 24 of the protective cover 2 in this state can function as a supporting point, allowing the portable device 3 to stand firmly on a plane with the assistance of the supporting structure jointly formed by the transmission device 1 and the protective cover 2.

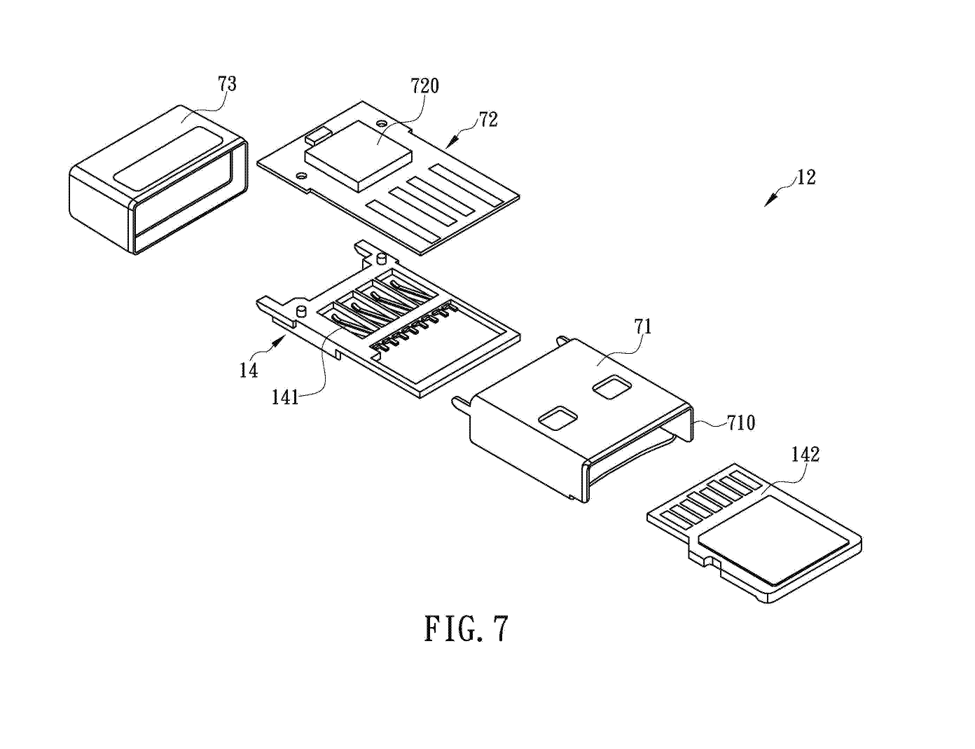

Moreover, the card reader 14 and the second transmission port 12 in this embodiment are assembled in the same enclosure to reduce the overall volume of the transmission device 1. Referring to FIG. 7 in conjunction with FIG. 1, the second transmission port 12 includes an outer enclosure 71 and a circuit module 72. The outer enclosure 71 is mounted at the second end of the housing 10. (In this embodiment, the outer enclosure 71 is embedded in the housing 10 via a rear enclosure 71.) The front end of the outer enclosure 71 is provided with an insertion hole 710. The circuit module 72 is provided in the outer enclosure 71 and has a circuit board that divides the interior space of the outer enclosure 71 into two parts. In other words, the back of the circuit module 72 is spaced from the inner wall of the outer enclosure 71, thus leaving room for the card reader 14.

The card reader 14 includes connection terminals 141 to be electrically connected to the transmission cable 13. In addition, the card reader 14 itself may be electrically connected to a processing unit 720 of the circuit module 72 so that, once the second transmission port 12 is connected to a computer, the computer can read data from a memory card 142 inserted in the card reader 14. It should be pointed out that the processing unit 720 may have a memory packaged therein for use as a data storage unit of the transmission device 1.

The above-mentioned descriptions represent merely the exemplary embodiment of the present invention, without any intention to limit the scope of the present invention thereto. Various equivalent changes, alternations or modifications based on the claims of present invention are all consequently viewed as being embraced by the scope of the present invention.

What is claimed is:

1. A transmission device having a data storage function and capable of being in a folded state by a magnetic force, comprising:
a housing having a middle section provided with a bending portion, wherein the bending portion is flexible;
a first transmission port provided at an end of the housing;
a second transmission port provided at an opposite end of the housing and having a transmission interface different from a transmission interface of the first transmission port;
a transmission cable provided in the housing and having two ends respectively and electrically connected to the first transmission port and the second transmission port;
a data storage unit electrically connected to at least one of the transmission ports; and
two magnetically attractive portions provided on a side of the housing and respectively adjacent to two opposite ends of the bending portion, wherein the magnetically attractive portions comprise a magnet and a magnetic element and are magnetically attachable to each other to render the transmission device into the folded state when the bending portion is bent.

2. The transmission device of claim 1, further comprising a protective cover, the protective cover comprising:
a first insertion opening provided at a first end of the protective cover and matching the first transmission port in size and configuration;
a second insertion opening provided at an opposite second end of the protective cover and matching the second transmission port in size and configuration;
a third insertion opening provided in a side, and adjacent to the first end, of the protective cover and matching the second transmission port in size and configuration; and
a curved portion provided in a middle section of the protective cover, wherein a distance between the first insertion opening and the curved portion corresponds to a distance between the second transmission port and the bending portion, and a distance between the second insertion opening and the curved portion corresponds to a distance between the first transmission port and the bending portion, in order for the second transmission port to be insertable into the second insertion opening while the first transmission port is inserted in the first insertion opening.

3. The transmission device of claim 2, wherein the third insertion opening is provided therein with an elastic ring made of an elastic material such that, when the second transmission port is inserted in the third insertion opening, the elastic ring is elastically deformed and is tightly engaged with the second transmission port.

4. The transmission device of claim 3, wherein the magnetically attractive portions comprise two magnets separately buried in the housing.

5. The transmission device of claim 4, wherein the transmission interface of the first transmission port is a mini-USB, micro-USB, Lighting, or USB Type-C interface while the transmission interface of the second transmission port is a USB interface.

6. A transmission device having a data storage function and capable of being in a folded state by a magnetic force, comprising:
a housing having a middle section provided with a bending portion, wherein the bending portion is flexible;
a first transmission port provided at a first end of the housing;
a second transmission port provided at an opposite second end of the housing and having a transmission interface different from a transmission interface of the first transmission port;
a transmission cable provided in the housing and having two ends respectively and electrically connected to the first transmission port and the second transmission port;
a card reader provided at the second end of the housing and electrically connected to the first transmission port; and
two magnetically attractive portions provided on a side of the housing and respectively adjacent to two opposite ends of the bending portion, wherein the magnetically attractive portions comprise a magnet and a magnetic element and are magnetically attachable to each other to render the transmission device into the folded state when the bending portion is bent.

7. The transmission device of claim 6, wherein the second transmission port comprises:
an outer enclosure mounted at the second end of the housing and having a front end provided with an insertion hole; and
a circuit module provided in the outer enclosure and electrically connected to the transmission cable, wherein the circuit module has a back spaced from an inner wall of the outer enclosure to make room for the card reader.

8. The transmission device of claim 7, further comprising a protective cover, the protective cover comprising:
a first insertion opening provided at a first end of the protective cover and matching the first transmission port in size and configuration;
a second insertion opening provided at an opposite second end of the protective cover and matching the second transmission port in size and configuration;
a third insertion opening provided in a side, and adjacent to the first end, of the protective cover and matching the second transmission port in size and configuration; and
a curved portion provided in a middle section of the protective cover, wherein a distance between the first insertion opening and the curved portion corresponds to a distance between the second transmission port and the bending portion, and a distance between the second insertion opening and the curved portion corresponds to a distance between the first transmission port and the bending portion, in order for the second transmission port to be insertable into the second insertion opening while the first transmission port is inserted in the first insertion opening.

9. The transmission device of claim 8, wherein the third insertion opening is provided therein with an elastic ring made of an elastic material such that, when the second transmission port is inserted in the third insertion opening, the elastic ring is elastically deformed and is tightly engaged with the second transmission port.

10. The transmission device of claim 9, wherein the magnetically attractive portions comprise two magnets separately buried in the housing.

11. The transmission device of claim 10, wherein the transmission interface of the first transmission port is a mini-USB, micro-USB, Lighting, or USB Type-C interface while the transmission interface of the second transmission port is a USB interface.
